(19) United States
(12) Patent Application Publication
(10) Pub. No.: US 2013/0193766 A1
(43) Pub. Date: Aug. 1, 2013

(54) CONTROL AND PROTECTION OF A DC POWER GRID

(71) Applicant: ATLANTIC GRID OPERATIONS A., LLC, Chevy Chase, MD (US)

(72) Inventors: Garth D. IRWIN, Winnipeg (CA); Dennis A. WOODFORD, Winnipeg (CA)

(73) Assignee: ATLANTIC GRID OPERATIONS A., LLC, Chevy Chase, MD (US)

(21) Appl. No.: 13/715,520

(22) Filed: Dec. 14, 2012

Related U.S. Application Data
(60) Provisional application No. 61/593,168, filed on Jan. 31, 2012.

(51) Int. Cl. H02M 1/32

(52) U.S. Cl. CPC H02M 1/32
USPC 307/82; 363/51

(57) ABSTRACT

A HVDC power grid including a multiplicity of voltage sourced converters arranged in a symmetrical monopole transmission configuration to transmit DC power over a DC power grid of transmission lines connected between the voltage sourced converters, and circuitry implemented for sensing and identifying a fault occurred on a section of a DC transmission line. In response to the sensing, the current on the faulted DC transmission line is controllably drawn down to a target current level, e.g., 50 amp, which will accommodate clearing of the faulted transmission line section by allowing switches located at each end of the faulted transmission line section to be able to open against such level of current without triggering an non-extinguishable or sustained arc across one of the switches. At least one of the switches is capable of opening when the current is reduced to the drawn down level to isolate the transmission line.

### FIELD OF THE INVENTION

Certain embodiments of the invention relate to the collection of wind generated energy from wind farms. More specifically, certain embodiments of the invention relate to system, apparatus and method for control and protection of a DC power grid.

### BACKGROUND OF THE INVENTION

High voltage is used for electric power transmission to reduce the energy lost in the resistance of the wires. High Voltage Direct Current (HVDC) is a technique to transmit electric power using DC voltage instead of alternating current (AC). HVDC is important for renewable energy integration, power flow control, as well as for future transmission grid architecture. HVDC transmission systems are a feasible and economical solution for power transmission over a long distance or using underground or underwater cable. For example, for long-distance transmission, HVDC transmission systems may be less expensive and suffer lower electrical losses. For underground or underwater power cables, HVDC transmission systems may avoid the heavy currents required to charge and discharge the cable capacitance each cycle.

HVDC transmission systems are well established in various applications such as, for example, bringing offshore wind power to shore, supplying oil and gas offshore platforms, interconnecting power grids in different countries and reinforcing existing AC grids. Multi-Terminal HVDC (MTDC) electric power transmission, which uses direct current for the bulk transmission of electrical power, allows for the use of a DC power grid electricity network. Power transmission systems have also benefitted from the development of voltage sourced converters (VSCs) which allows for more adaptable MTDC systems and for HVDC transmissions to be implemented into DC power grids with a large number of VSCs.

A DC circuit, also called a DC network, is an interconnected set of components that operates from DC electricity. A DC power grid is formulized or formed when more than two converter stations are interconnected on the DC side via DC cables or overhead lines. DC networks may be considered as technical advances from HVDC and MTDC. A DC power grid may have a single or multiple DC voltage levels. The advantages of DC networks are in flexibility and security in addition to numerous capital and operating cost incentives. In developing high power large DC power grids, achieving similar levels of reliability and performance as with AC grids are expected.

Further limitations and disadvantages of conventional and traditional approaches will become apparent to one of skill in the art, through comparison of such systems with some aspects of the present invention as set forth in the remainder of the present application with reference to the drawings.

### SUMMARY OF THE INVENTION

Systems, apparatus and methods for control and protection of a DC power grid, substantially as shown in and/or described in connection with at least one of the figures, are set forth herein and in the claims. More specifically, systems and methods can be implemented that for example provide for fault protection or control of high voltage Direct Current (DC) power grids. The systems and methods can include a multiplicity of two or more voltage sourced converters arranged in a symmetrical monopole transmission configuration to transmit DC power over transmission lines between the multiplicity of voltage sourced converters. Circuitry can also be implemented that senses when a ground fault occurs on a section of any transmission line and identifies which section is so faulted. The systems and methods can in response to the sensing, controllably draw down current on the faulted transmission line to a level which will accommodate clearing of the faulted transmission line section by allowing switches located at each end of the faulted transmission line section to be able to open against such level of current without resulting in a sustained arc across one or more of the switches. A central controller can be implemented to provide such functionality. The central controller or other desired component(s) opens at least one or more or even all of the switches opened when the current is reduced to the drawn down level to thus isolate the transmission line.

Another embodiment of the invention also relates to a method for protecting a high voltage DC power grid from a fault, by collecting energy from an energy resource using a first DC grid configuration of the high voltage DC power grid; identifying a fault in the first DC grid configuration; isolating the fault in the first DC grid configuration; re-routing the energy from the first DC configuration to a second DC configuration of the DC power grid; and delivering the energy to any alternating current (AC) power system using the second DC configuration.

The invention also relates to a method for restoring DC voltage of both poles of a DC grid with ungrounded symmetrical monopole configuration which comprises detecting once a line to ground fault is detected, the central controller inhibiting s the normal voltage controlling functions of the DC choppers usually located on the dc poles of the transmission line at each voltage sourced converter connected to the alternating current (AC) system, and releasing such inhibition once the faulted transmission line has been cleared, the central controller releases its restraint on the voltage controlling function of so that the DC choppers so they can act to balance the pole voltages of the DC grid still in operation, with the inhibiting and releasing conducted by a central controller.

The creation of transient negligible or minor arc may be common in the operation of electrical circuitry. For example, when an electrical switch is opened from a closed state, a short harmless arc may sometimes be experienced when the switch is first opened while the contact of the switch is physically close to each other during the physical operation of opening the switch. This minor low energy arcs are typically not a concern. Non-extinguishable or sustained arcs, such as a high energy arc that may be experienced when the voltage across the opened or partially opened switch is high enough to form an arc across the switch may damage the switch, related circuitry, or systems.

A transmission line comprises any series arrangement of overhead transmission lines, underground cables and underwater cables suitable for transmitting DC power through positive and negative polarities. An ungrounded configuration or circuit refers to a circuit or circuit component arrangement in which the circuit or component is insulated from being connected to ground through the high value of resistances of normal insulating material and equipment including the high resistance of surge arresters operating up to normal rated voltages. A circuit or system can sometimes be designed include a component that includes a ground connection to address various exigencies but are not designed in their general operation to use the ground to form an electrical circuit. This includes the resistance of normal insulation of cables, insulators, bushings and other equipment such as transformers. An ungrounded design may also include a floating ground.

In an exemplary embodiment of the invention, one or more operating voltage sourced converters may generate a supplemental oscillatory DC side voltage signal to add an oscillating current that may be superimposed on the drawn down DC current in the faulted transmission line to facilitate the successful switching of that faulted transmission line by creating current zeros. In some examples, some of the voltage sourced converters are connected to wind farms comprising a multiplicity of two or more wind turbine generators, the remainder of the voltage sourced converters are connected to an AC power system, and the current on the faulted transmission line is reduced to the desired level for switching by varying output DC voltage at the ends of the transmission line by those designated voltage sourced converters controlling DC voltage. In some examples, set points at the designated voltage sourced converters are adjusted to reduce the current on the transmission line to the desired level for switching if a pole to ground line fault is identified in the transmission line. Total power generated by the wind farms may be adjusted based on total power rating of the voltage sourced converters receiving from the wind farms. In accordance with the adjusted total power generated by the wind farms, one or more of the wind turbine generators of the wind farms may be shut down or the maximum power limit of the one or more of the wind turbine generators of the wind farms may be reduced.

In some examples, each AC busbar that connects each voltage sourced converter receiving power from the wind farms may be controlled to operate in various frequencies.

In some examples, a central grid controller associated with the high voltage DC power grid may control or manage operation and/or configuration of all of the voltage sourced converters and the switches. The central grid controller may manage the high voltage DC power grid to isolate the region in the DC power grid surrounding the ground fault by lowering pole to pole DC voltage of the high voltage DC power grid and/or current in the switches on the faulted transmission line. In some examples, high speed DC circuit breakers may be placed on each transmission line to be opened in order to create the isolation.

In some examples, the high voltage DC power grid supports multiple DC grid configurations. In some instances, the high voltage DC power grid is configured to collect energy from a wind farm using a first DC grid configuration. When a fault is identified or sensed in the first DC grid configuration, the high voltage DC power grid may be configured to re-rout the energy collected from the first DC configuration to a second DC configuration of the high voltage DC power grid, and continues delivering of the energy to a utility grid using the second DC configuration. In some instances, if in the process of isolating the fault in the first DC grid configuration there is an excess of power generated from the wind farms that temporarily cannot be delivered to any AC power system, it may, for one reason or another, lead to undesirable disconnection of wind turbine generators on any wind farm. The three phase AC shorting breakers connected to the tertiary windings of interface transformers with voltage sourced converters impacted by the undesirable disconnection of wind turbine generators may temporarily close to generate an apparent AC system low voltage or AC fault such that the wind turbine generators may detect and remain connected providing the AC system low voltage, or the detected AC fault is contained within the voltage ride through characteristic standard adhered to by the operation of the wind turbine generators.

Detecting, in the DC power grid, a pole-ground-to-pole fault or a pole-to-pole fault, may cause all AC circuit breakers connecting every voltage sourced converter in the DC power grid to open and close down the entire DC power grid until the DC fault is identified and cleared by the switches at each end of the faulted line section. Voltage sourced converters in the DC grid may respond to reduce DC voltage or DC current that also may close down the entire grid. When so cleared all operable voltage sourced converters and wind farms may be restarted for operation into the second DC configuration of the DC power grid. If high speed DC circuit breakers are installed or placed on the each transmission line to be disconnected so as to sectionalize the DC power grid and so isolate the region closest to the fault so that only that close in region will close down, and the other segmented regions will return to an operable condition determined by the second DC configuration of the DC power grid.

These and other advantages, aspects and novel features of the present invention, as well as details of an illustrated embodiment thereof, will be more fully understood from the following description and drawings.

### BRIEF DESCRIPTION OF THE DRAWINGS

FIG. 1 is a diagram illustrating a single power conversion stage of an exemplary DC power grid connecting to a wind farm and an AC power system, in accordance with an embodiment of the invention.

FIG. 2 is a diagram illustrating multiple power conversion stages of an exemplary DC power grid connecting to a wind farm and an AC power system, in accordance with an embodiment of the invention.

FIG. 3 is a diagram illustrating exemplary steps utilized to identify and clear a transmission line fault in a DC power grid, in accordance with an embodiment of the invention.

FIG. 4 is a diagram illustrating exemplary steps utilized to maintain power transmission over a DC power grid when a single pole fault is identified in the DC power grid, in accordance with an embodiment of the invention.

FIG. 5 is a diagram illustrating exemplary steps utilized for single pole fault isolation in a DC power grid, in accordance with an embodiment of the invention.

### DETAILED DESCRIPTION OF THE INVENTION

A system or method may be implemented to assist with managing high voltage direct current (HVDC) transmission lines and handling ground faults in HVDC transmission lines. Voltage sourced converters may be utilized to transmit power over the transmission network. Ground faults can cause damages to the transmission network, which may cause significant disruptions and financial loss to the power supplier. The system and method can detect ground faults such as in an ungrounded symmetrical monopole transmission configuration and controllably draw down the current on the transmission line through control action of designated voltage sourced converters. Switches on the transmission lines can be triggered when the current drops close to zero. Conventional (inexpensive switches or breakers) can be implemented on the transmission lines, e.g., at each end of the transmission lines that are triggered when the current drops close to zero and which would not be impacted but the risk of arcing due to the reduction of the current.

In accordance with various exemplary embodiments of the invention, the DC power grid may be configured to clear such faults and restore transmission within one second, for example, using conventional and relatively fast mechanical single pole circuit breakers or switches. Such circuit breakers or switches may be placed at the ends of each DC transmission line section in the DC power grid and are henceforth referred to as switches. Furthermore, the system or the DC power grid may comprise, for example, ungrounded symmetrical monopole voltage sourced converters receiving power from or to wind farms and AC system connected through VSC converter stations. The DC power grid may also comprise a transmission backbone and feeders to AC system VSC converter terminations.

Methods and systems for fault management in a high voltage direct current (DC) power grid are further described herein. Various embodiments of the invention may comprise arranging a multiplicity of two or more voltage sourced converters in a symmetrical monopole transmission configuration to transmit DC power over a network or DC power grid of transmission lines connected between the multiplicity of voltage sourced converters, implementing circuitry for sensing when a ground fault occurs on a section of the transmission line and identifying which section is so faulted, in response to the sensing, controllably drawing down the current on the transmission line to a level, zero with a margin of 50 amp, for example, which will accommodate clearing of the faulted transmission line section through control action of designated voltage sourced converters to allow switches located at each end of the faulted transmission line section to be able to open against such level of current without resulting in a non-extinguishable or sustained arc across one or more of the switches, and opening at one or all of the switches associated with the faulted pole of the faulted line section and all switches connected to possibly one end of the unfaulted pole on the faulted line section when the current is reduced to the drawn down level to thus isolate the transmission line. The switches on the other end of the unfaulted pole of the faulted line section if still closed may open when the voltage of that pole is returned to its normal rated value.

In an exemplary embodiment of the invention, a central grid controller may be applied to schedule the power flow in the DC power grid. The DC power grid may be configured to arrange a multiplicity of voltage sourced converters in a symmetrical monopole transmission configuration to transmit DC power over a network or DC power grid of transmission lines connected between the multiplicity of voltage sourced converters. For example, some of the voltage sourced converters may be electronically connected to wind farms. The remainder of the voltage sourced converters may be capable of being electronically connected to an AC power system. The DC transmission lines may be utilized to transmit DC power to supply power to various utility grids. In an exemplary embodiment of the invention, a DC transmission line comprises any series arrangement of overhead transmission lines, underground cables and underwater cables suitable for transmitting DC power through both positive and negative polarities. A switch or switches may be placed at each end of the poles in the DC transmission line. In addition, the switches in the DC power grid are capable of opening from a closed state in a period of time equal to or less than approximately 70 milliseconds, for example.

In an exemplary embodiment of the invention, the central grid controller may comprise or implement circuitry for sensing or identifying a line fault on a DC transmission line of the DC power grid. In this regard, the central grid controller may signal or communicate with voltage sourced converters on the faulted DC transmission line such that the voltage sourced converters on the faulted DC transmission line may be enabled or triggered to reduce the current on the faulted DC transmission line to a target current level or a drawn down level. The central grid controller may select or determine the target current level that will accommodate clearing of the faulted DC transmission line section by allowing switches located at each end of the faulted transmission line section to be able to open against such level of current without resulting in a non-extinguishable or sustained arc across one or more of the switches.

In addition, the central grid controller may manage or configure the DC power grid such that all switches to the faulted pole of the faulted transmission line and at least one set of switches at one end of the unfaulted pole of the faulted transmission line section are caused to open when the current is reduced to the selected target current level to thus isolate the faulted DC transmission line. For example, all—the switches associated with the faulted transmission line that are caused to be opened do so when the current is reduced below approximately 50 amp. Upon receiving signaling or instruction from the central grid controller for the line fault, the switches on the faulted transmission line section in the DC power grid are capable of opening from a closed state in a period of time equal to or less than approximately 70 milliseconds, for example. The other set of switches on the unfaulted pole that have not opened may open when the voltage of that pole has been reduced to its normal rating.

In another exemplary embodiment of the invention, the grid central controller may expedite the process to bring current on the faulted DC transmission line to or close to the selected target current level such as zero or close to zero by adjusting voltages of active voltage sourced converters in the DC power grid. In this regard, one or more operating voltage sourced converters may generate a supplemental oscillatory DC side voltage signal to add an oscillating current that may be superimposed on the drawn down DC current in the faulted transmission line to facilitate the successful switching of that faulted transmission line by creating current zeros. For example, the central grid controller of the DC power grid may vary the voltage of an active voltage sourced converter in the DC power grid achieving or creating a ripple current that passes through the faulted DC transmission line. Subsequently, the central grid controller may send a signal to the ends of the faulted DC transmission line for the switches to open at the selected target current level. The switches on the faulted DC transmission line may open at the selected target current level in response to the signaling received from the central grid controller. After the switches on the faulted DC transmission line are open, the central grid controller may send signals to the voltage sourced converter to adjust the pole to pole voltage of the DC power grid, and to the wind farms to reduce power generated by the wind farms, respectively.

In an exemplary embodiment of the invention, the central grid controller may manage the operation or action sequence needed to clear a faulted DC transmission line section after the location and type of the line fault has been sensed and identified. The central grid controller may schedule the power flow in the DC power grid, accordingly. When a pole to ground line fault has been discriminated or identified, the central grid controller, during scheduling power flow through the faulted DC transmission line section, will adjust set points at all applicable or designated voltage sourced converters to reduce the DC current through the faulted line section to the selected target current level, zero or a value less than approximately 50 amps, for example. This will accommodate the clearing of the faulted DC transmission line section by opening switches located at each end of the faulted DC line section that have the capacity to open against such a level of DC current. The central grid controller may, for example, be connected to some or all voltage sourced converters in the DC power grid through a secure, redundant and fast telecommunications network.

In another exemplary embodiment of the invention, multiple configurations may be applied to the DC power grid for protecting the DC power grid from a fault. In this regard, the DC power grid may be operable to collect wind energy, for example, generated from wind farms using a first configuration of the DC power grid. The DC power grid may identify a fault in a first transmission line of the DC power grid. In an exemplary embodiment of the invention, the DC power grid may be configured to isolate the fault by opening switches on the first transmission line on either side of the fault in each pole. The DC power grid may route or re-routing energy from the first configuration of the DC power grid to a resultant configuration of the DC power grid via the remaining transmission lines and voltage sourced converters in the DC power grid. The DC power grid may be instructed by the central grid controller to adjust the wind farm power and the voltage sourced converters connected to the AC power system. The DC power grid may deliver or forward the wind energy to the AC power system, accordingly. In some instances, while isolating the fault in the first DC grid configuration there may be an excess of power generated from the wind farms. In this case, three phase AC shorting breakers, which are connected to the tertiary windings of interface transformers with voltage sourced converters impacted by the possible undesirable disconnection of wind turbine generators, may temporarily close to avoid undesirable disconnection of wind turbine generators on any wind farm. In some instances, high speed DC circuit breakers may be installed or placed on selected transmission lines so as to sectionalize the DC power grid and isolate the region closest to the fault while keeping the other segmented regions in an operable condition determined by the second DC configuration of the DC power grid.

In another exemplary embodiment of the invention, the fault in the DC power grid may be, for example, a pole-to-ground fault. This may include the situation where a pole-to-ground fault in one pole progresses to a pole-to-ground fault in the other pole after a time delay greater than required to clear the initial pole-to-ground fault. All electronic connections in the DC power grid may, for example, operate as if each fault in the progression from pole-to-ground to the other pole are independent pole-to-ground faults and be cleared as such.

In another exemplary embodiment of the invention, in instances where a pole-to-pole or a pole-to-ground-to-pole fault occurs in one DC transmission line, it may require fault clearing by the opening of all AC circuit breakers connecting each ungrounded voltage sourced converter to the DC power grid or some voltage sourced converters in the dc grid may respond to reduce DC voltage or DC current that also may close down the entire grid. To limit the number of ungrounded voltage sourced converters, which must be disconnected from their AC network by the opening of their AC circuit breaker or from specific voltage sourced converters, high speed DC circuit breakers when available for commercial application may be strategically placed or located throughout the DC power grid to rapidly segment the portion of the DC power grid that is faulted so that only the AC circuit breakers on the faulted and isolated segment open to clear the fault. The segments of the DC power grid when so isolated from the faulted segment may continue to function without the AC circuit breakers of their ungrounded voltage sourced converters needing to open to clear the fault.

Another embodiment of the invention is to install the commonly applied DC choppers on the DC poles that are connected from each pole conductor to ground on the DC transmission lines located at one or more of the VSC converter stations connected to the AC system. The DC chopper's normal function is to contain DC overvoltages on the DC transmission lines if they should so occur, particularly from faults nearby in the AC system. When a single pole-to-ground fault occurs on any one transmission line in the DC grid with its symmetrical monopole configuration, the operation of the DC choppers is temporarily inhibited by the central controller until the faulted DC line section is cleared, at which time the central controller restores the DC chopper's function to perform their normally designed action to return the DC pole voltages of the remaining operating segment or segments of the DC power grid to their normal values.

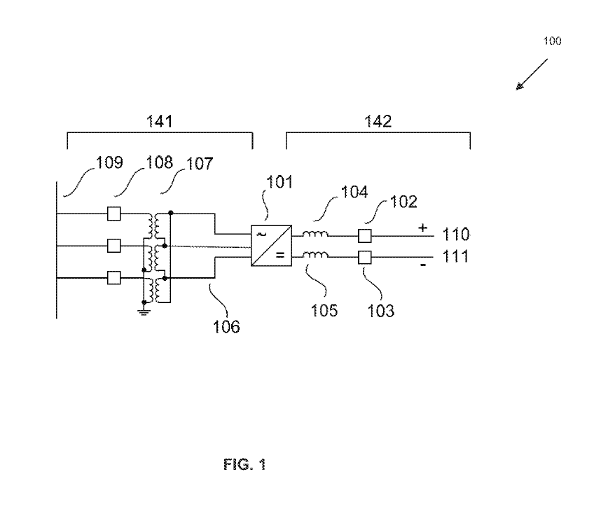

FIG. 1 is a diagram illustrating a single power conversion stage of an exemplary DC power grid connecting to a wind farm and an AC power system, in accordance with an embodiment of the invention. Referring to FIG. 1, there is shown a power conversion stage 100 of a DC power grid. The power conversion stage 100 comprises a voltage sourced converter (VSC) 101.

The VSC 101 may comprise suitable logic, circuitry, interfaces and/or code that are operable to convert power from the AC side 141 to the DC side 142 or the other way round. In an exemplary embodiment of the invention, the VSC 101 may be high resistance grounded or ungrounded, hereafter designated as ungrounded in normal operation and minimizing the negative effect of transmission line faults.

U.S. Pat. No. 7,206,211 (hereafter, the '211 patent) provides basic operation and control of a VSC, in what is commonly understood as two and three level VSC configurations. The '211 patent discloses a VSC that utilizes pulse width modulation (PWM) to provide electric power transfer from AC to DC and vice versa. PWM helps in providing voltage peaks across the semiconductor elements at certain levels employing certain control methods. U.S. Pat. No. 4,941,079 (hereafter, the '079 patent) provides use of VSC transmission with PWM. U.S. Pat. No. 7,848,120 (hereafter, the '120 patent) discloses a PWM process for VSCs, including example methods for active power control, DC voltage regulation and apparent power (reactive power) at the terminals to the AC system to which the VSC is connected. U.S. Pat. No. 7,239,535 (hereafter, the '535 patent) and U.S. Pat. No. 5,991,176 (hereafter, the '176 patent) disclose methods similar to those in the '120 patent. U.S. Pat. No. 7,321,500 (hereafter, the '500 patent) discloses pulse width modulation in VSCs. The '500 patent discloses two states of control using PWM, of which one state is for steady state operation and control is switched to the other state when disturbances or transients normally less than one second, for example, in duration occur. The control state for steady state operation discussed in the '500 patent selectively eliminates harmonics thereby reducing switching losses but has almost no dynamic control capability; hence the need arises for another control state. U.S. Pat. No. 7,729,142 (hereafter, the '142 patent) discloses multi-terminal HVDC converter stations, including two multi-terminal HVDC transmission schemes using thyristor based converters, commonly known as line commutated converters (LCC).

In an exemplary embodiment of the invention, the VSC 101 may be implemented as a two-level or modular multilevel VSC. The VSC 101 may be used rather than other types of converters for multi-terminal HVDC transmission systems such as large HVDC transmission grids. The VSC 101 in HVDC transmission scheme is also referred to as a HVDC converter.

VSCs such as the VSC 101 may be configured to collect energy from various energy resources such as renewable and non-renewable energy resources. Exemplary renewable resources may comprise wind farms, solar, geothermal, and biomass. Exemplary non-renewable resources may comprise oil, natural gas, and coal. The VSC 101 may be operable to convert the collected energy to electrical energy for utility grids. In an exemplary embodiment of the invention, HVDC converters such as the VSC 101 may be connected to wind farms if the wind turbines in the farms may generate an AC voltage independent of an associated AC system. U.S. Pat. No. 8,018,083 (hereafter, the '083 patent) discloses and demonstrates methods of how the AC voltage at the terminals of wind turbine generators may be converted to DC voltage and connected to an HVDC converter.

On the AC side 141 of the VSC 101, the VSC 101 behaves approximately as a current source, injecting both grid-frequency and harmonic currents into an associated AC network. The AC side 141 of the VSC 101 comprises a three-phase line feeder 106, unit or interface transformers 107, AC circuit breakers 108, and an AC three phase interconnection busbar 109. The unit or interface transformers 107 may comprise three single phase transformers 107a, 107b and 107c, or a single three phase transformer. In an embodiment of the invention, the primary or AC side three phase winding of the interface transformers 107 may be conventional grounded star connected. The secondary or DC side three phase winding of the interface transformers 107 may be ungrounded star or delta connected. The AC circuit breakers 108 comprise transformers 108a, 108b and 108c.

On the DC side 142 of the VSC 101, the VSC 101 serves as a voltage source. In an exemplary embodiment of the invention, the VSC 101 may be controlled or signaled to reduce the DC current to a target current level when a line-to-ground pole fault occurs on an associated DC transmission line. In this regard, the voltage of the DC side 142 of the VSC 101 may be adjusted or varied achieving a ripple current when a line fault occurs. The switches on the faulted DC transmission line may be capable of opening from a closed state in a period of time equal to or less than approximately 70 milliseconds, for example, upon the detection of the line fault. The DC side 142 of the VSC 101 comprises mechanical or DC circuit breakers or switches 102 and 103, line inductors 104 and 105, a positive DC output connection 110, and a negative DC output connection 111.

The line inductors 104 and 105 may comprise suitable logic, circuitry, interfaces and/or code that are operable to limit the rate of change of the current flowing through the DC side 142 of the VSC 101, thus improving the stability of the current control loop.

The DC circuit breakers or switches 102 and 103 may be configured to include suitable logic, circuitry, interfaces and/or code that are operable to protect DC electrical circuit from damage caused by overload, for example. A DC circuit breaker in HVDC transmission scheme is also referred to as a HVDC circuit breaker. U.S. Pat. No. 4,216,513 (hereafter, the '513 patent) discloses the use of HVDC circuit breakers in LCC and VSC transmission systems. Future developments in HVDC circuit breakers are expected which may operate at very high speeds of 5 milliseconds or less, for example.

In an exemplary operation, the VSC 101 connects to the interface transformers 107 through the three-phase line feeder 106. The three-phase line feeder 106 may or may not have ungrounded AC shunt filters or reactors connected to it. The single phase transformers 107a, 107b and 107c connect to the AC three phase interconnection busbar 109 through the AC circuit breakers 108a, 108b and 108c, respectively. The interface transformers 107 may be a three phase transformer instead of three single phase transformers 107a, 107b and 107c. The positive DC output connection 110 and the negative DC output connection 111 each may pass through the line inductors 104 and 105, and the DC circuit breakers 102 and 103.

In an exemplary embodiment of the invention, the VSC 101 may be managed to reduce the DC current to a target current level upon detection of a line-to-ground fault on an associated DC transmission line. For example, in instances where such a line fault occurs in a DC transmission line on which the DC circuit breaker or switch 102, for example, is located, the DC circuit breaker or switch 102 may be capable of opening from a closed state in a period of time equal to or less than approximately 70 milliseconds, for example, upon the detection of the line fault. In this regard, the output voltage of the DC side 142 of the VSC 101 may be adjusted or varied achieving a ripple current output. The current on the faulted DC transmission line may be brought down to or close to a target current level such as approximately zero to enable opening of the DC circuit breaker or switch 102 within 70 milliseconds, for example, subsequent to the detection of the line fault.

The VAC 101 may be configured to support various HVDC configuration schemes such as, for example, monopole, bipolar, symmetric monopole, back-to-back and multi-terminal This invention applies only to the configuration of symmetric monopole. VAC 101 may have capability to reduce DC voltage or DC current to zero which would apply for pole-to-ground-to-pole or pole-to-pole faults.

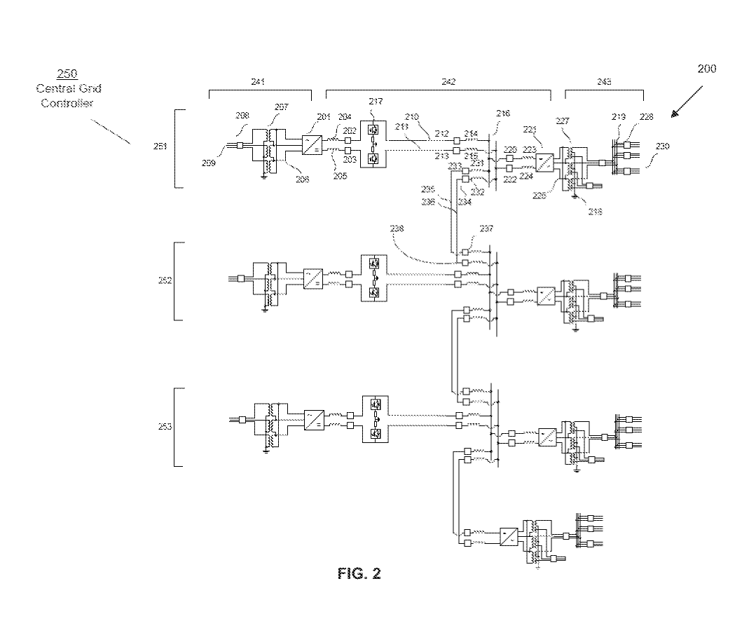

FIG. 2 is a diagram illustrating multiple power conversion stages of an exemplary DC power grid connecting to a wind farm and an AC power system, in accordance with an embodiment of the invention. Referring to FIG. 2, there is shown a DC power grid 200. The DC power grid 200 may comprise various DC grid configurations 251, 252 and 253, for example. The DC grid configurations 252 and 253 each may comprise the same or similar components as the DC grid configuration 251. The multiple DC grid configurations 251, 252 and 253 may be managed or configured by a central grid controller 250.

Although three DC grid configurations 251, 252 and 253 of the same DC power grid 200 are illustrated in FIG. 2 to support bulk power transfer, the invention is not so limited. In this regard, an infinite number of the same or different DC grid configurations in the same DC power grid 200 may be implemented or realized to support bulk power transfer without departing from the spirit and scope of the various embodiments of the invention.

In an exemplary embodiment of the invention, transmission lines of the DC power grid 200 may be selected from a group of underground cables, underwater cables, overhead DC transmission lines, and any combination thereof. A DC grid configuration such as the DC grid configuration 251 may comprise multiple power converter stages such as, for example, the VSCs 201 and 221, receiving power from or to wind farms and an AC system. The VSC 201 may comprise suitable logic, circuitry, interfaces and/or code that are operable to convert power from the AC side 241 to the DC side 242 of the VSC 201 or the other way round. In an exemplary embodiment of the invention, the VSC 201 may be an ungrounded voltage sourced converter in symmetrical monopole transmission configuration capable of being electronically connected to an AC power system. The VSC 221 may comprise suitable logic, circuitry, interfaces and/or code that are operable to convert power from the AC side 243 to the DC side 242 of the VSC 221 or the other way round. In an exemplary embodiment of the invention, the VSC 221 may be an ungrounded voltage sourced converter in symmetrical monopole transmission configuration and electronically connected to wind farms 230.

The AC side 241 of the VSC 201 comprises a three-phase line feeder 206, unit or interface transformers 207, three phase AC circuit breakers 208, and an AC interconnection busbar 209. The unit or interface transformers 207 may comprise three single phase transformers or a single three phase transformer. The three phase AC circuit breakers 208 may comprise transformers 208a, 208b and 208c.

The DC side 242 of the VSC 201 comprises mechanical or DC circuit breakers or switches 202 and 203, line inductors 204 and 205, a positive DC output connection 210, a negative DC output connection 211, DC circuit breakers or switches 212 and 213, line inductors 214, 215, 231 and 232, DC bus work 216, DC choppers 217, switches 233 and 234, backbone transmission lines 235 and 236. In an exemplary embodiment of the invention, the DC transmission line feeders 210 and 211 may be, for example, undersea cables, underground cables, overhead DC transmission lines, or any combination thereof. The switches may be selected from a group of mechanical switches, single pole mechanical circuit breakers and DC circuit breakers.

The VSC 221 may comprise suitable logic, circuitry, interfaces and/or code that are operable to convert power from the AC side 243 to the DC side 242 of the VSC 221 or the other way round. The VSC 221 may comprise suitable logic, circuitry, interfaces and/or code that are operable to convert power from the AC side 243 to the DC side 242 of the VSC 221 or the other way round.

The AC side 243 comprises a three-phase line feeder 226, unit or interface transformers 227, an AC interconnection busbar 219, AC circuit breakers 228 and energy resources such as wind farms 230. The unit or interface transformers 227 may comprise three single phase transformers 227a, 227b and 227c. The wind farms 230 may connect to the VSC 221 through the three-phase line feeders 226, set of the interface transformers 227 and set of the AC circuit breakers 228.

In various embodiment of the invention, converter stations may be configured in various ways such as, for example, Cable Ring Configuration to Connect Wind Farms to Offshore Converters. One or more full bridge converters may be placed at each converter station to support various DC fault clearing strategies.

Although the wind farms 230 are illustrated in FIG. 2 to serve as energy resources to the DC power grid 200 for utility grids, the invention is not so limited. In this regard, various other forms of energy resources such as, for example, solar, geothermal, biomass, oil, natural gas, and coal may also serve energy resources to the DC power grid 200 for utility grids without departing from the spirit and scope of the various embodiments of the invention.

In various exemplary embodiments of the invention, the VSCs 201 and 221 may be ungrounded symmetrical monopole. The transformers 227a, 227b and 227c may comprise tertiary windings 218 such as, for example, a low voltage three phase delta configured AC winding. The tertiary windings 218 may comprise AC mechanical or solid state shorting circuit breakers 218 that may be connected directly to ground or that may be connected to ground through one or more phase reactors. In an exemplary embodiment of the invention, the tertiary windings 218 may be short circuited when the operation of the DC power grid 200 or the VSC 221 experiences a fault that causes the AC voltage to rise on the AC interconnection busbar 219. Optional procedures may comprise implementing three phase or single phase AC circuit breakers, or the use of VSC action to control the AC voltage reference, and the use of shorting elements directly on the AC interconnection busbar 219. Line faults in the DC power grid 200 or the VSC 221 may result in the interconnected wind farms 230 operating into an open circuit or an apparent open circuit, causing wind turbine generators of the wind farms 230 to trip out of service. If a fault in the DC power grid 200 or the VSC 221 is of short duration, the tertiary windings 218, which may, for example, be temporarily shorted to ground or shorted to ground through a reactor, may prevent a voltage overload on the AC interconnection busbar 219 and the VSC 221. A trip by the wind turbine generators may take several hours to restore. Preventing such an overvoltage may allow the wind turbine generators of the wind farms 230 to temporarily prevent the movement of energy into the DC power grid 200 to prevent the wind farms 230 from tripping out of service and may keep the wind turbines from being completely shut down due to the overvoltage.

The DC power grid 200 may function or act as a “smart grid” if the central grid controller 250 is applied. The central grid controller 250 may comprise suitable logic, circuitry, interfaces and/or code that are operable to perform a variety of tasks such as, for example, managing or controlling of various DC grid configurations of the DC power grid 200. In this regard, the central grid controller 250 may be operable to control settings and operations of various components such as ungrounded voltage sourced converters and switches of the DC power grid 200. In an exemplary embodiment of the invention, the central grid controller 250 may be operable to manage or set the multiple DC grid configurations 251, 252 and 253 for the DC power grid 200. The central grid controller 250 may communicate with the DC power grid 200 in various ways such as wired or wireless. In this regard, the central grid controller 250 may connect to the entire of VSCs in the DC power grid 200 through a secure, redundant and fast telecommunications network. The central grid controller 250 may comprise memory to store information such as executable instructions and data that may be utilized for control and protection of the DC power grid 200. The executable instructions may comprise various algorithms utilized by the central grid controller 250 for control and protection of the DC power grid 200. The data may comprise various configuration parameter values for the DC power grid 200. The memory may comprise RAM, ROM, low latency nonvolatile memory such as flash memory and/or other suitable electronic data storage.

In various exemplary embodiments of the invention, the central grid controller 250 may be operable to identify and clear a fault in a DC transmission line of the DC power grid 200. In this regard, the central grid controller 250 may comprise or implement circuitry necessary for sensing or detecting a line fault on a DC transmission line of the DC power grid 200. The central grid controller 250 may signal or communicate with voltage sourced converters such like the VSC 221 on the faulted DC transmission line so as to reduce the current on the faulted DC transmission line to a target current level. The central grid controller 250 may select or determine the target current level such as, for example, zero with a margin of 50 amps, that will accommodate clearing of the faulted DC transmission line section by allowing the switches located at each end of the faulted transmission line section to be able to open against such level of current without resulting in a non-extinguishable or sustained arc across one of the switches. In addition, the central grid controller 250 may manage or configure switches on the faulted transmission line section to open when the current is reduced to the selected target current level to thus isolate the faulted DC transmission line.

The central grid controller 250 may manage and coordinate the operation sequence needed to enable a faulted DC transmission line section to be cleared after the location and type of line fault has been identified. The central grid controller 250 may schedule or manage the power flow or transmission over the DC power grid 200, accordingly. For example, the central grid controller 250 may be operable to manage the DC power grid 200 to provide or implement one or more first ungrounded voltage sourced converters such as, for example, the VSC 221, in symmetrical monopole transmission configuration. Each of the first VSCs may be capable of being electronically connected to one or more wind farms 230. The central grid controller 250 may manage the DC power grid 200 to provide or implement one or more second ungrounded voltage sourced converters such as, for example, the VSC 201, in symmetrical monopole transmission configuration each capable of being electronically connected to an AC power system.

In this regard, the total power rating of the wind farm 230 may be higher than the total power rating of the second ungrounded voltage sourced converters. In this regard, the wind farms 230 may be configured or signaled to shutdown a portion or the entire of the wind turbine generators. In other words, the wind turbine generators may be in a total or limited shutdown state. In an exemplary embodiment of the invention, in some instances, a pole to ground line fault has been discriminated or identified, the central grid controller 250 in scheduling power flow through the faulted DC transmission line section may adjust set points at all applicable VSCs to reduce the DC current through the faulted line section to zero or to a value less than approximately 50 amps, for example. This may accommodate the clearing of the faulted DC transmission line section by opening switches, for example, the switches 220 and 222, located at each end of the faulted DC line section that have the capacity to open against such a level of DC current.

The central grid controller 250 may manage or configure the DC power grid 200 to provide one or more DC transmission lines that are electronically connected to the first ungrounded voltage sourced converters and to the second ungrounded voltage sourced converters. In an exemplary embodiment of the invention, the faulted DC transmission line may comprise switches in each pole at each end. The central grid controller 250 may manage or configure the DC power grid 200 to enable opening of the switches from a closed state in a period of time equal to or less than approximately 70 milliseconds, for example, after the location and type of line fault has been identified. In this regard, the DC power grid 200 may be configured to provide a DC transmission line electronically connected to a voltage sourced converter such as the VSC 221. A switch, for example, the switches 212, 213, 220 and 222, may be provided or located at each end of the DC transmission line in each pole. The DC power grid 200 may be managed to reduce current on the faulted DC transmission line to a target current level upon the detection of a pole to ground line fault in the DC power grid 200.

For example, a ripple current that passes through the faulted DC transmission line may be created by varying the voltage of an active voltage sourced converter such as the VSC 221. The central grid controller 250 may send a signal or signals to the ends of the faulted DC transmission line for the switches to open at the target current level. The switches such as the switches 212, 213, 220 and 222 may open at the target current value in response to the signaling received from the central grid controller 250 to isolate the line fault. In addition, the central grid controller 250 may send signals to the voltage sourced converter such as the VSC 221 to adjust the pole to pole voltage of the DC power grid 200. After the switches on the faulted DC transmission line are open, the central grid controller 250 may send signals to the voltage sourced converter such as the VSC 221 to adjust the pole to pole voltage of the DC power grid 200, and may send signals to the wind farms 230 to reduce generated power of the wind farms 230, respectively.

In various exemplary embodiments of the invention, the central grid controller 250 may be operable to protect the DC power grid 200 from a DC transmission line fault. In this regard, the central grid controller 250 may manage or configure the DC power grid 200 to collect wind energy generated from the wind farms 230, for example, using a first configuration 251 of the DC power grid 200. The central grid controller 250 may manage or configure the DC power grid 200 to identify a pole to ground fault in a first DC transmission line of the DC power grid 200. The central grid controller 250 may manage or configure the DC power grid 200 to isolate the fault by opening switches on the first DC transmission line on either side of the fault in each pole.

For example, the DC power grid 200 may open the switches from a closed state in a period of time equal to or less than approximately 70 milliseconds, for example. The central grid controller 250 may manage or configure the DC power grid 200 to route or re-route the wind energy from the first configuration 251 of the DC power grid 200 to a resultant configuration 252, for example, of the DC power grid 200 via the remaining transmission lines and VSCs in the DC power grid 200. The central grid controller 250 may determine or select DC grid configuration settings for the DC power grid 200. For example, the DC grid configuration settings may comprise various adjustments to the wind farm power and the voltage sourced converters connected to the AC power system. The central grid controller 250 may signal the DC power grid 200 with the selected DC grid configuration settings for corresponding DC grid configurations. The central grid controller 250 may manage the DC power grid 200 to deliver or forward the wind energy to an AC power system, accordingly.

In an exemplary embodiment of the invention, the line fault in the DC power grid 200 may comprise a pole-to-ground fault or a fault where a pole-to-ground fault in one pole progresses to a pole-to-ground fault in the other pole after a time delay greater than required to clear the initial pole-to-ground fault. Under such circumstances, the initial pole-to-ground fault will be cleared so that the progression to a pole-to-ground fault in the other pole will be cleared also as a pole-to-ground fault and not require the separate protective action of an instantaneous pole-to-ground-to-pole fault or a pole-to-pole fault.

In an exemplary embodiment of the invention, in instances where a pole-to-pole or a pole-to-ground-to-pole fault occurs in one DC transmission line of the DC power grid 200, the fault may be cleared by opening of all AC circuit breakers, for example, the AC circuit breakers 208a, 208b, 208c, 228a, 228b, and 228c, connecting each ungrounded voltage sourced converter such as the VSC 201 to the DC power grid 200 or some voltage sourced converters in the dc grid may respond to the fault to reduce DC voltage or DC current to zero that also may close down the entire grid. In an exemplary embodiment of the invention, to limit the number of ungrounded voltage sourced converters such as the VSC 201 that must be disconnected from their AC network by the opening of their AC circuit breaker or from voltage sourced converters reducing their DC voltage or current to zero, high speed DC circuit breakers when available for commercial application may be strategically placed throughout the DC power grid 200 to rapidly segment the portion of the DC power grid 200 that is faulted so that only the AC circuit breakers on the faulted and isolated segment open to clear the fault. The segments of the DC power grid 200 when so isolated from the faulted segment may continue to function without the AC circuit breakers of their ungrounded voltage sourced converters needing to open to clear the fault.

In an exemplary operation, energy from the wind farms 230 may, for example, travel through the AC side 243, through the VSC 221 and through the line inductors 223 and 224 and the DC circuit breakers 220 and 222 to the bus work 216. The energy collected from the wind farms 230 may then travel through the line inductors 214 and 215 and the DC circuit breakers 212 and 213 to the DC transmission line feeders 210 and 211 or may travel through the line inductors 231 and 232 and the DC circuit breakers 233 and 234 to the second DC grid configuration 252. If the energy travels through the DC transmission line feeders 210 and 211, it may travel past the DC choppers 217, through the DC circuit breakers 204 and 205 and the line inductors 204 and 205 to the VSC 201, and then through the AC system 206 and interconnects with the AC system 206. The VSCs 201 and 221 may connect to the backbone DC transmission lines 235 and 236, either directly or indirectly through the DC transmission line feeders 210 and 211. In an embodiment of the invention, the operation of the backbone DC transmission lines 235 and 236 may be managed to support various DC fault clearing strategies.

The switches 233, 234, 237 and 238 on the backbone transmission lines 235 and 236 may, for example, employ fast DC circuit breakers to divide the DC power grid 200 into independent grids. This is particularly helpful, for example, when pole to pole or pole to ground to pole faults occur. Reactors may be added to the ends of the DC transmission lines 235 and 236 for basic system design considerations.

In an exemplary embodiment of the present invention, the VSCs 201 and 227 may be ungrounded and arranged in a symmetrical monopole transmission configuration. While the VSCs 201 and 221 may be connected to a path to ground through a switch, the switch is left open under normal circumstances, causing the VSCs 201 and 221 to be ungrounded. It may be preferable for the VSCs 201 and 221 to be ungrounded to keep the converter capacitors charged, causing the power from the wind farms 230 to continue to flow into the rest of the DC power grid 200 during and after a single pole to ground fault in one or more components of the DC power grid 200, for example, in a transmission line. The DC transmission line feeders 210 and 211 may be terminated at each end for both positive and negative DC voltage polarity. In an exemplary embodiment of the present invention, each end of each transmission lines 210 and 211 may comprise in each pole, for example, a single pole mechanical circuit breaker or circuit switch 202, 203, 212 and/or 213 that is capable of opening from the closed state within approximately 70 milliseconds, for example, or less from the time it receives a signal to open and may be capable of opening with a minimum level of DC current flowing through it. As an alternative to a single pole mechanical circuit breaker or circuit switch, the DC transmission lines 210 and 211 may comprise DC circuit breakers capable of breaking DC load current, to break the load current through the DC transmission line.

A DC transmission line, for example the DC transmission lines 210 or 211, may be faulted to ground in the abnormal circumstance when, for example, the DC transmission line is exposed to water or other elements of nature due to, for example, broken insulation or lightning. When a pole of a DC transmission line is so faulted, the DC voltage of all active DC transmission lines in the DC power grid 200 of the same polarity as the one faulted section of the DC transmission line may discharge to a DC voltage of zero or near zero. At the same time, all DC transmission lines in the DC power grid 200 of opposite polarity to the faulted transmission line may charge to a voltage of twice or near twice the rated pole to ground voltage of the power system, for example.

In an exemplary embodiment of the present invention, the faulted transmission line with a single pole to ground fault may be isolated and cleared to re-balance the system with DC choppers 217 under the control of the central controller. To isolate either of the DC transmission lines 210 or 211, the DC circuit breakers or switches 202, 203, 212 and 213 may be opened at a current zero or near current zero. However, to open the DC circuit breakers or switches 202, 203, 212 and 213, the DC current through the DC transmission line should be zero or close to zero. Once the DC pole to ground fault is detected, a telecommunications system may be used to send the measured DC current to the VSC 201 which may control or manage the current flow through the DC transmission lines 210 and 211 to zero or near zero. To ensure that the current flow is zero or near zero, the VSC 201 may be managed or configured to reduce the current on the faulted DC transmission line to a target current level that will accommodate clearing of the faulted DC transmission line section by allowing switches located at each end of the faulted transmission line section to be able to open against such level of current without resulting in a non-extinguishable or sustained arc across one of the switches. For example, the VSC 201 may be managed to fluctuate its DC voltage or DC current slightly to generate a small modulated AC current that may be utilized to create an oscillating current in the faulted DC transmission line 210, 211, 235 and/or 236. This oscillating current may assist mechanical circuit breakers or circuit switches 202, 203, 212 and 213 in opening and clearing the faulted transmission line by causing zero or near zero current crossings through its superposition on any residual DC current in the transmission line. The same may, for example, apply to the switches 233, 234, 237 and 238 if the single pole to ground fault occurs on the backbone transmission lines 235 and 236. Other actions to assist in creating the necessary current zeros or near current zeros may comprise lowering the pole to pole DC voltage of the DC power grid 200 and lowering the magnitude of the wind generated power from the wind farms 230 to levels that do not exceed the power rating of remaining VSCs connected to the DC power grid 200 or interface to the AC system 209. Blocking of strategic VSCs may also be applied.

During a single pole to ground fault on any DC transmission lines in the DC power grid 200, the DC choppers 217 may be inhibited from operating by the central controller in order to reduce the current through the DC transmission line end switches on the faulted DC transmission line that may clear the fault.

After the circuit breakers 202, 203, 212 and 213 are opened and the faulted transmission line with its pole-to-ground fault is cleared, the DC choppers 217, which may be, for example, connected to both poles of the faulted DC transmission line, may be returned to their basic DC overvoltage reduction function by the central controller to quickly restore the DC voltage of both poles in the DC power grid 200 to their normal rated balanced levels. The DC voltage of the DC power grid 200 may restore the rated pole to pole DC voltage if previously reduced during the DC fault clearing process. The amount of time that the DC power grid 200 takes to identify and clear a fault and to balance the DC grid voltage and restore operation may, for example, be approximately 0-200 milliseconds, 0-150 milliseconds, 0-100 milliseconds, 0-70 milliseconds, 40-70 milliseconds, 40-60 milliseconds, 35-45 milliseconds, 40-50 milliseconds, or other ranges or combinations of ranges. Identifying and clearing a pole-to-ground fault in such a short amount of time may allow for the wind farms 230 to ride through the faulted part of the DC power grid 200. If the DC power grid 200 takes longer periods of time to identify and clear a fault, DC grid overvoltage at the unfaulted pole may adversely impact the insulation in the equipment of the DC power grid 200 or cause it to deteriorate. If pole to pole faults or pole to ground to pole faults occur, the whole DC power grid 200 may need to be cleared with the AC circuit breakers 208 and 228 or by the action of specific voltage sourced converters comprised in the DC grid.

During this process, the wind farms 230 may cease to generate power. Such an interruption in wind power may require a system restart of remaining DC grid equipment and wind turbines in the wind farms 230. After the grid voltage is restored, energy from the wind farms 230 that was previously flowing through faulted DC transmission lines 210 and 211 and entering the AC system 209 through the interconnection 209 may re-route through the DC transmission lines 235 and 236 to other configurations of the DC power grid 200, for example, the configurations 252 and 253. Therefore, a single pole to ground fault may not result in a fault current. In this regard, load current may still flow in all transmission lines including the faulted transmission line and the power generated from the wind farms 230 may be delivered to the AC system 209 through the DC power grid 200 despite the fault.

A VSC may overload, however, if the total power generated by the wind farms 230 connected to a particular VSC exceed the total maximum steady state rating of that VSC after the faulted section of the DC transmission lines 210 and 211 is cleared. If the total power generated by all such wind farms 230 exceeds the maximum steady state rating of the VSC that they are connected to, a multiplicity of wind turbine generators in the connected wind farms 230 may be switched out of service. In an exemplary embodiment of the invention, even if a mode of control of the VSC is invoked that limits the power flow through it to within its rating, the total generated power from the wind farms 230 may have to be reduced to within the rating of the VSC. Alternatively, to avoid such an overload, the maximum power limit of the wind farms 230 may be reduced to below the steady state rating of the VSC within a short period of time, for example, in 100 milliseconds or less if the wind turbine generators in the wind farms 230 have such a capability. A signal may be generated to switch the wind farms 230 out of service or to quickly reduce their maximum power limit after a VSC detects that an overload is imminent.

In an exemplary embodiment of the present invention, the DC power grid 200 may also comprise grounded metal oxide surge arresters spread throughout DC power grid 200. Metal oxide surge arresters may provide further protection for overvoltages to the circuit element near which the surge arrester is connected. After a fault is identified, DC current accumulated in the metal oxide surge arresters and DC transmission line conductance may pass through the DC transmission lines 210 and 211 and the circuit breakers 202, 203, 212 and 213 to the fault, which may cause the circuit breakers 202, 203, 212 and 213 to fail to open because the necessary current zero is not reached. The circuit breakers 202, 203, 212 and 213 may have an inherent capability to open and clear small DC currents, but may, for example, not open if the current is too strong. If the metal oxide surge arresters use external series gaps or rated to high enough voltage, the necessary current zeros may more readily achieved.

After the fault is cleared and normal DC voltage is restored, the DC current in each metal oxide surge arrester may reduce to very small values. In an exemplary embodiment of the invention, the insulation coordination undertaken so that voltage ratings of the metal oxide surge arresters and gaps if applied may be designed to not operate during normal single pole DC transmission line faults. The accumulated DC current from the metal oxide surge arresters may also be held small enough to allow the mechanical circuit breakers or circuit switches in the faulted DC transmission line to open. Use of the DC converters 201 and 221 to bring measured DC currents in the single pole to ground faulted DC transmission to zero, or to create a temporary reference level of power or DC current to zero and by the possible temporary lowering of the DC grid pole to pole DC voltage, or possible tripping of selected wind turbines, or by superimposing an oscillating current may assist in assuring the current zeros or near current zero are reached to clear the faulted DC transmission line.

In an exemplary embodiment of the invention, if the wind farms 230 are shut down after the DC power grid 200 experiences a single pole to ground fault and the fault is identified and cleared, such as in the DC transmission lines 210 and 211, the VSC 201 may also be disconnected from the rest of the DC power grid 200. However, while the disconnected VSC 201 may not operate within the DC power grid 200 to move energy through the interface transformer 207 and into the AC system 209, the VSC 201 may be operated as an AC system voltage controlling Static Synchronous Compensator (STATCOM).

In an exemplary embodiment of the invention, one or more of the VSCs 201 terminating into the AC system 209 may control DC pole to pole voltage for the entire DC power grid 200 while all other VSCs 201 terminating into the AC system 209 may control DC current or DC power. The capability of controlling DC voltage may be switched from one VSC 201 to any other VSC that terminates into the AC system 209. Ungrounded symmetrical monopole VSCs may be built to control either DC pole to pole voltage or to control DC current or DC power. In this regard, the VSC 201 may be adapted to operate in DC pole to pole voltage control mode. Alternatively, each DC converter may be controlled through a prior art of DC voltage droop control.

In an exemplary embodiment of the invention, the VSC 221 may also comprise a frequency control to allow power from the wind farms 230 to be automatically transferred to the DC power grid 200. This frequency control may hold the frequency of the AC voltage generated at the interface AC busbar 219 at any value such as, for example, 50 or 60 Hz. In an exemplary embodiment of the invention, the converter 221 may operate with an independent clock. In this regard, the converter 221 may be operable to support a fixed or variable frequency AC network. In alternative control mode for the VSC 221 may be invoked that controls power flow through it to within its rating. In this regard, the VSC 221 may be configured to allow switching to a control mode that limits or prevents DC overcurrent.

The DC power grid 200 may also comprise a secure and fast telecommunication system that may provide central control and monitoring to all VSCs 201 and 221 and line end mechanical circuit breakers or circuit switches 202, 203, 212 and 213, as well as other system components. In an exemplary embodiment of the invention, the secure and fast telecommunication system may also adjust the amount of power entering the DC power grid 200 from the wind farms 230 and into the AC system 209 to avoid VSC overloads and to achieve the system's optimum operating conditions and post fault power schedules. The secure and fast telecommunication system may allow the system to accommodate future expansion of the DC power grid 200. In an exemplary embodiment of the invention, the secure and fast telecommunication system may connect all the VSCs in the DC power grid 200 to the central grid controller 250. In this regard, the central grid controller 250 may schedule the power flow and manage the sequence needed to enable a faulted DC transmission line section to be cleared after the location and type of line fault has been identified.

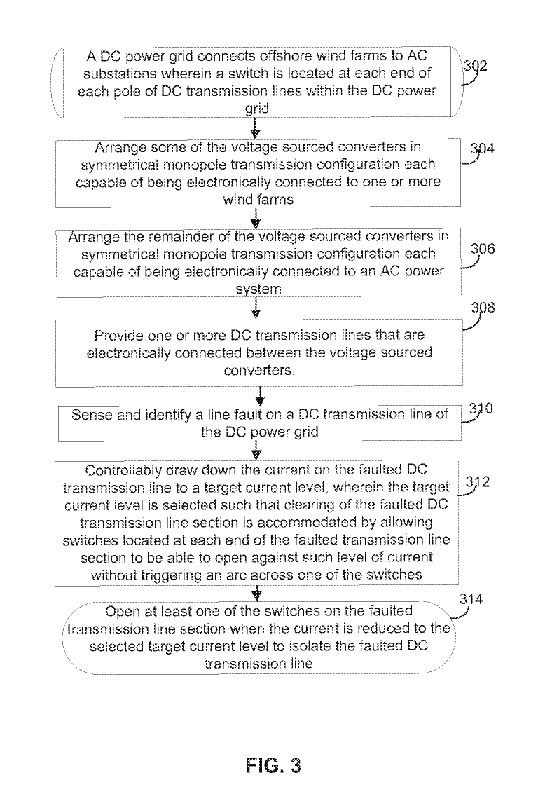

FIG. 3 is a diagram illustrating exemplary steps utilized to identify and clear a transmission line fault in a DC power grid, in accordance with an embodiment of the invention. Referring to FIG. 3, in step 302, a HVDC grid such as the DC power grid 200 connects offshore wind farms to AC substations. Switches are located at each end of each pole of DC transmission lines within the HVDC grid. The exemplary steps start with step 304, where the HVDC grid is configured to arrange or provide the voltage sourced converters in symmetrical monopole transmission configuration each capable of being electronically connected to one or more wind farms. In step 306, the HVDC grid is configured to arrange or provide the remainder of the voltage sourced converters in symmetrical monopole transmission configuration each capable of being electronically connected to an AC power system. In step 308, the HVDC grid is configured to provide or arrange one or more DC transmission lines that are electronically connected between the voltage sourced converters. In an exemplary embodiment of the invention, one or more switches are placed or located at each end of each pole of DC transmission lines within the HVDC grid. In step 310, the central grid controller 250 may sense or identify a line to ground fault on a DC transmission line of the DC power grid 200. In step 312, the central grid controller 250 may signal or configure the DC power grid 200 to controllably draw down or reduce the current on the faulted DC transmission line section to a target current level. The target current level such as, for example, zero amps but with a margin of approximately 50 amps, is selected by the central grid controller 250 in order to accommodate clearing of the faulted DC transmission line section by allowing switches located at each end of the faulted transmission line section to be able to open against such level of current without allowing a non-extinguishable or sustained arc across one or more of the switches. The central grid controller 250 may implement or enable the necessary control functions so as to controllably draw down or reduce the current on the faulted DC transmission line section to the target current level.

The control functions may comprise, for example, operation coordination, current control, power balance or control, overload protection, steady-state control, priority switching, setpoint control, and controlled start-up and disconnection of the designated designated voltage sourced converters, and an superimposed oscillating current on the drawn down current through the faulted transmission line. The rate or ranges of rates at which the current can be controllably drawn down are as fast as the controls and DC grid can accommodate, which should in the range of 10 to 30 milliseconds. In step 314, the central grid controller 250 may manage or configure the DC power grid 200 such that all of the switches on the faulted transmission line section to open when the current is reduced to the selected target current level in order to thus isolate the faulted DC transmission line. For instance, all four or more of the switches associated with the faulted transmission line are opened when the current is reduced below approximately 50 amp. Upon receiving signaling or instruction from the central grid controller 250 for the line fault, the switches on the faulted transmission line section in the DC power grid 250 are capable of opening from a closed state in a period of time equal to or less than approximately 70 milliseconds, for example.

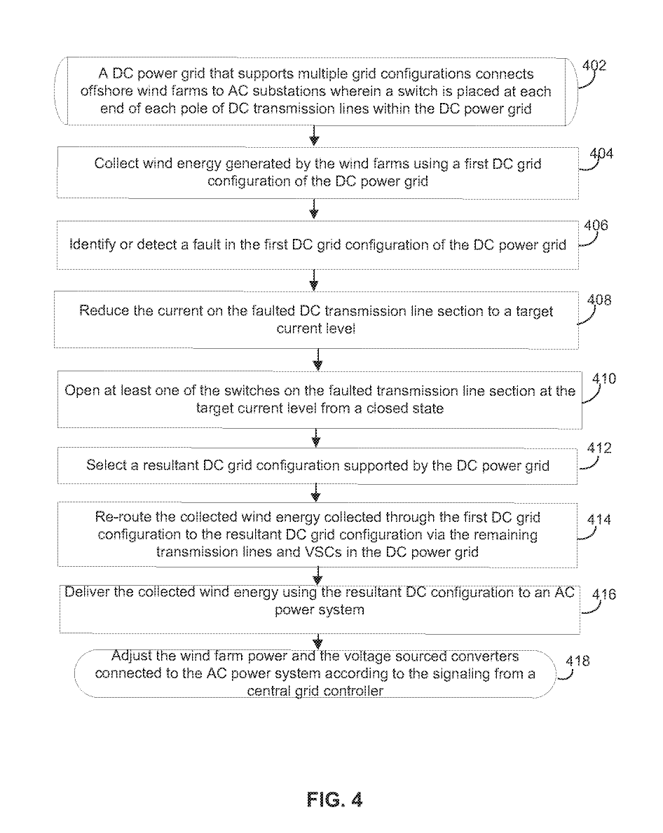

FIG. 4 is a diagram illustrating exemplary steps utilized to maintain power transmission over a DC power grid when a single pole fault is identified in the DC power grid, in accordance with an embodiment of the invention. Referring to FIG. 4, in step 402, a DC power grid such as the DC power grid 200 that is configured to support multiple grid configurations connects offshore wind farms 230 to AC substations. One or more switches may be placed or located at each end of each pole of DC transmission lines within the DC power grid 200. The exemplary steps start with step 404, where the DC power grid 200 is configured to collect wind energy generated from the wind farms 230 using a first DC grid configuration 251 of the DC power grid 200. In step 406, the central grid controller 250 for the DC power grid 200 comprises circuitry to sense, identify or detect a fault in the first DC transmission configuration of the DC power grid 200. In step 408, the central grid controller 250 may signal the DC power grid 200 to reduce current on the faulted DC transmission line section to a target current level so as to enable or trigger the switches on the faulted DC transmission line to open.

In this regard, the central grid controller may select or determine the target current level such as, for example, zero amps with a margin of 50 amps with a possible superimposed current oscillation, that will accommodate clearing of the faulted DC transmission line section by allowing switches located at each end of the faulted transmission line section to be able to open against such level of current without resulting in a non-extinguishable or sustained arc across any or all of the switches. In step 410, upon receiving signaling or instruction from the central grid controller 250 for the line fault, the switches on the faulted transmission line section in the DC power grid 200 are capable of opening from a closed state in a period of time equal to or less than approximately 70 milliseconds, for example. In this regard, the central grid controller 250 may manage or configure the DC power grid 200 such that the switches on the faulted transmission line section to open when the current is reduced to the selected target current level, zero amps with a margin of 50 amps with a possible superimposed current oscillation, for example, to isolate the faulted DC transmission line. In step 412, the central grid controller 250 may select a resultant DC grid configuration such as the configuration 252 for the DC power grid 200. The DC power grid 200 may be enabled to route or re-route the collected wind energy through the first DC grid configuration of the DC power grid 251 to the resultant DC grid configuration 252 of the DC power grid 200 via the remaining transmission lines and VSCs in the DC power grid 200. In step 414, the DC power grid 200 may deliver or forward the collected wind energy to an AC power system using the resultant DC grid configuration 252. In step 416, the central grid controller 250 may determine or modify DC grid configuration settings for the DC power grid 200. The central grid controller 250 may signal the DC power grid 200 with the determined DC grid configuration settings. The DC power grid 200 may adjust the wind farm power and settings of the voltage sourced converters connected to the AC power system according to the signaling from the central grid controller 250.

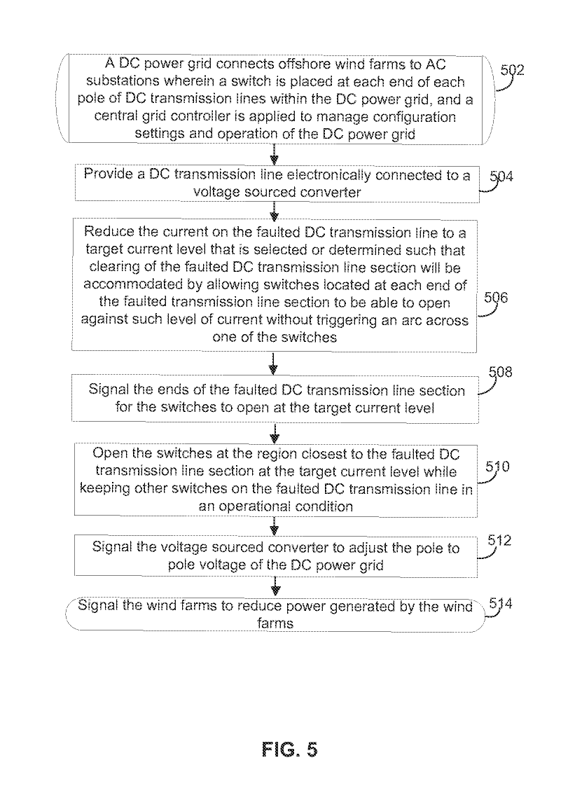

FIG. 5 is a diagram illustrating exemplary steps utilized for single pole fault isolation in a DC power grid, in accordance with an embodiment of the invention. Referring to FIG. 5, in step 502, a DC power grid such as the DC power grid 200 that is configured to support multiple DC grid configurations connects offshore wind farms 230 to AC substations. Switches may be placed or located at each end of each pole of DC transmission lines within the DC power grid 200. The central grid controller 250 is applied or provided to manage or configure settings and operation of the DC power grid 200. The exemplary steps start with step 504, where the DC power grid 200 is configured or arranged by the central grid controller 250 to provide a DC transmission line electronically connected to a voltage sourced converter. In step 506, the central grid controller 250 may signal the DC power grid 200 to reduce the current on the faulted DC transmission line to a target current level, zero with a margin of 50 amp, for example.

In this regard, the DC power grid 200 may be configured to generate a supplemental oscillatory DC side voltage signal to add an oscillating current that may be superimposed on the drawn down DC current in the faulted transmission line to facilitate the successful switching of that faulted transmission line by creating current zeros or a current level approaching current zero. For example, the DC power grid 200 may be enabled to vary the voltage of an active or designated voltage sourced converter creating a ripple current that passes through the faulted DC transmission line. The target current level is selected or determined by the central grid controller 250 such that clearing of the faulted DC transmission line section may be accommodated by allowing switches located at each end of the faulted transmission line section to be able to open against such level of current without resulting in a non-extinguishable or sustained arc across any or all of the switches. In step 508, the central grid controller 250 may send a signal to the ends of the faulted DC transmission line for the switches to open at the target current level. In step 510, the DC power grid 200 may open the switches at the region closest to the faulted DC transmission line section at the target current level while keeping other switches in an operable condition. In step 512, the central grid controller 250 may send signals to the voltage sourced converter to adjust the pole to pole voltage of the DC power grid 200. In step 514, the central grid controller 250 may send signals to the wind farms 230 to reduce power generated power by the wind farms 230.

The embodiments and examples described above are exemplary only. One skilled in the art may recognize variations from the embodiments specifically described here, which are intended to be within the scope of this disclosure and invention. As such, the invention is limited only by the following claims. Thus, it is intended that the present invention cover the modifications of this invention provided they come within the scope of the appended claims and their equivalents.

It is to be understood that the present invention is not limited to the particular methodology, configuration, compounds, materials, manufacturing techniques, uses, and applications described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements, and includes equivalents thereof known to those skilled in the art. Similarly, for another example, a reference to “a step” or “a means” is a reference to one or more steps or means and may include sub-steps or subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices and materials are described although any methods, techniques, devices, or materials similar or equivalent to those described may be used in the practice or testing of the present invention. Structures described herein are to be understood also to refer to functional equivalents of such structures.

All patents and other publications are incorporated herein by reference in their entirety to the extent necessary for a complete understanding of all embodiments of the invention or for the purpose of describing and disclosing, for example, the methodologies described in such publications that might be useful in connection with the present invention. These publications are provided solely for their disclosure prior to the filing date of the present application. Nothing in this regard should be construed as an admission that the inventors are not entitled to antedate such disclosure by virtue of prior invention or for any other reason.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for control and protection of a DC power grid.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for fault management in a high voltage direct current (DC) power grid, comprising:
arranging a multiplicity of two or more voltage sourced converters in a symmetrical monopole transmission configuration to transmit DC power over a network or DC power grid of transmission lines connected between the multiplicity of voltage sourced converters;
implementing circuitry for sensing when a ground fault occurs on a section of any transmission line and identifying which section is so faulted;
in response to the sensing, controllably drawing down the current on the transmission line to a level which will accommodate clearing of the faulted transmission line section through control action of designated voltage sourced converters to allow switches located at each end of the identified, faulted transmission line section to be able to open against such level of current without triggering a non-extinguishable arc across one of the switches; and
opening at least one of the switches when the current is reduced to the drawn down level to thus isolate the transmission line that has the faulted section.

2. The method according to claim 1, comprising generating a supplemental oscillatory DC side voltage signal by one or more operating voltage sourced converters to add an oscillating current that is superimposed on the drawn down DC current in the faulted transmission line to facilitate the successful switching of that faulted transmission line by creating current zeros or currents near zero.

3. The method according to claim 1, wherein all four or more of the switches associated with the faulted transmission line are opened when the current is reduced below approximately 50 amp.

4. The method according to claim 1, wherein some of the voltage sourced converters are connected to wind farms comprising a multiplicity of two or more wind turbine generators, the remainder of the voltage sourced converters are connected to an alternating current (AC) power system, and the current on the faulted transmission line is reduced to the level by varying output DC voltage at the ends of the transmission line by those designated voltage sourced converters controlling DC voltage whose DC voltage set points can be adjusted by various functions from the central controller or by local droop characteristics.

5. The method according to claim 4, comprising adjusting set points at the designated voltage sourced converters to reduce the current on the transmission line to the level if a pole to ground line fault is identified in the transmission line.

6. The method according to claim 4, comprising adjusting total power generated by the wind farms based on total power rating of the voltage sourced converters receiving from said wind farms.

7. The method according to claim 6, comprising either shutting down one or more of the wind turbine generators in accordance with the adjusted total power generated by the wind farms or reducing the maximum power limit that can be generated by one or more of the wind turbine generators.

8. The method according to claim 4, comprising controlling a frequency of an AC voltage at each AC busbar that connects each voltage sourced converter receiving power from the wind farms.

9. The method according to claim 4, comprising controlling by a central grid controller associated with the high voltage DC power grid, operation and/or configuration of all of the voltage sourced converters, and the switches.

10. The method according to claim 1, comprising isolating the region in the DC power grid surrounding the ground fault by lowering pole to pole DC voltage of the high voltage DC power grid and/or current in the switches on the faulted transmission line.

11. The method according to claim 10, comprising placing one or more high speed DC circuit breakers on each transmission line to be disconnected in order to create the isolation.

12. A system for use with a high voltage Direct Current (DC) power grid comprising:
a multiplicity of two or more voltage sourced converters arranged in a symmetrical monopole transmission configuration to transmit DC power over transmission lines between the multiplicity of voltage sourced converters;
circuitry implemented that senses when a ground fault occurs on a section of any transmission line and identifying which section is so faulted; and
a central controller which, in response to the sensing, controllably draws down current on the faulted transmission line to a level which will accommodate clearing of the faulted transmission line section by allowing switches located at each end of the faulted transmission line section to be able to open against such level of current without resulting in a sustained arc across one or more of the switches,
wherein the central controller opens at least one or more of the switches opened when the current is reduced to the drawn down level to thus isolate the transmission line.

13. The system according to claim 12, wherein a supplemental oscillatory DC side voltage signal is generated by one or more operating voltage sourced converters to add an oscillating current that is superimposed on the drawn down DC current in the faulted transmission line to facilitate the successful switching of that faulted transmission line by creating current zeros or current levels approaching current zero.

14. The system according to claim 12, wherein the central controller opens the at least any or all of the switches when the current is reduced below approximately 50 amp.

15. The system according to claim 12, wherein some of the voltage sourced converters are connected to wind farms comprising a multiplicity of wind turbine generators, the remainder of the voltage sourced converters are connected to an alternating current (AC) power system, and the current on the faulted transmission line is reduced to the level by varying output DC voltage at the ends of the transmission line by those designated voltage sourced converters controlling DC voltage whose DC voltage set points can be adjusted by various functions from the central controller or by local droop characteristics.

16. The system according to claim 15, wherein set points at the designated voltage sourced converters are adjusted to reduce the current on the transmission line to the level if a pole to ground line fault is identified in the transmission line.

17. The system according to claim 15, wherein total power generated by the wind farms is adjusted based on total power rating of the voltage sourced converters receiving from said wind farms.

18. The system according to claim 17, wherein one or more of the wind turbine generators are shut down in accordance with the adjusted total power generated by the wind farms, or the maximum power limit that can be generated by the one or more of the wind turbine generators are reduced.

19. The system according to claim 15, further comprising an interface AC busbar connecting each of one or more of the voltage sourced converters to its associated wind farms, wherein each voltage sourced converters so connected comprises a frequency control to control a frequency of an AC voltage at the AC busbar.

20. The system according to claim 15, wherein the central controller is a central grid controller capable of controlling operation and/or configuration of any or all voltage sourced converters, switches, AC circuit breakers, AC shorting circuit breakers and any high speed DC circuit breakers, as well as DC choppers.

21. The system according to claim 15, further comprising one or more DC choppers, one or more metal oxide surge arresters, and at any voltage sourced converter receiving power from wind farms feeding directly to it that the interface transformer includes a tertiary winding whose voltage and rating are typical for such a winding and that has a three phase AC shorting circuit breaker connected to that tertiary winding either directly or through a three phase reactor.

22. A method for protecting a high voltage Direct Current (DC) power grid from a fault, the method comprising:
collecting energy from an energy resource using a first DC grid configuration of the high voltage DC power grid;
identifying a fault in the first DC grid configuration;
isolating the fault in the first DC grid configuration;
re-routing the energy from the first DC configuration to a second DC configuration of the DC power grid; and
delivering the energy to any alternating current (AC) power system using the second DC configuration.

23. A method for restoring Direct Current (DC) voltage of both poles of a DC grid with ungrounded symmetrical monopole configuration which comprises detecting a line to ground fault, inhibiting normal voltage controlling functions of DC choppers located on the dc poles of the transmission line at each voltage sourced converter connected to the alternating current (AC) system, and releasing such inhibition once the faulted transmission line has been cleared, so that the DC choppers can act to balance the pole voltages of the DC grid still in operation, with the inhibiting and releasing conducted by a central controller.
